(19) United States
(12) Patent Application Publication
(10) Pub. No.: US 2007/0263811 A1
(43) Pub. Date: Nov. 15, 2007

(54) Telephone instrument used in conjunction with computer

(76) Inventors: Kuan-Nung Lin, Taipei City (TW); Jia-Lung Huang, Hsin-Tien City (TW)

Correspondence Address: TROXELL LAW OFFICE PLLC, SUITE 1404, 5205 LEESBURG PIKE, FALLS CHURCH, VA, 22041, US

(21) Appl. No.: 11/403,893

(22) Filed: Apr. 14, 2006

(51) Int. Cl. H04M 15/06; H04M 1/56

(52) U.S. Cl. 379/142.15

(57) ABSTRACT

When comprising a telephone and a computer in an integrated environment by connecting them together in the manner of interlink or junction via wired or wireless data/audio connection interface (RS232, USB, Firewire), the functions of the computer (such as unique processing power, internet integration and database capabilities) can be integrated in a seamless fashion with the telephone instrument, and where it can receive and interpret the telephone's signaling information and where this signaling data can then be used by the computer. The signaling information mentioned here includes but not limited to off-hook and on-hook signaling, outbound dialing, connecting, disconnecting, incoming call display and incoming call ring. For example, to start or to stop voice recording, to playback call recordings, to accept key signals as well as to control and operate all the functions and keys on the telephone (including but not limited to dialing, keypad lock/unlock and message waiting LED on/off activation), to further increase the functionality and efficiency of the telephone. The switching device on the telephone can be used to switch a single electro-acoustical conversion device, such as headset, to either the computer (soundcard) or the telephone (telephone network) in an automatic fashion as interpreted and controlled by the computer, or alternatively in a manual fashion as required by the user. Thus, it will reduce the cost of required equipment and further increase the feasibility and efficiency of the telephone.

### BACKGROUND OF THE INVENTION

1. Field of the Invention

The present invention relates to a telephone instrument, and more particularly to a telephone instrument which is linked to a computer via data and audio connection interfaces, so that communication between the two devices can occur for purposes of sending and receiving data information, voice recording of telephone calls and playback thereof, key press signals, telephony line and exchange signals and to give the computer the capacity to process all telephone related functions via the telephone instrument, thereby increasing the functionality, automation and efficiency of the telephone instrument.

2. Description of Related Technology

Given the conventional communication equipment and its functionality, both the computer and the telephone instrument are necessary components of the total solution. The computer has features such as great processing power, internet integration and database capabilities, regardless of whether it is a desktop, notebook or hand-held device; and a telephone instrument (fixed line) includes functions such as off-hook and on-hook signaling, outbound dialing, connecting, disconnecting, incoming call display, and incoming call ring. At the present stage, though computers are being used for VOIP (voice over IP) applications while connected to the Internet such as Skype and MSN, Internet phones are still unable to replace the current fixed line telephones. Moreover, the conventional fixed line telephone device does not have the equivalent functions of processing power, internet integration and database capabilities as in a computer. Therefore, conventional telephone devices cannot satisfy all telephone usage needs of a computer user, such as customer service center, stock and security control, marketing campaigns, voice recording, market research or survey, telesales, and in all those industries that require the usage of phone and information technology to communicate with customers, suppliers and internal staff.

Therefore, companies usually need to operate the computer and its software applications separately from the telephone network, thereby decreasing productivity levels, where ideally, both the computer and its software applications should be fully integrated with the telephone network.

For example: (A) Customer service companies need to answer calls and at the same time type in the customer's account number to be able to access that customer's information details, thus wasting precious time and projecting a level of inefficiency to the customer.

(B) Marketing companies require their tele-agents to gather a variety of customer data from their contacts, such as telephone number, address, name and products or services of interest.

In some cases, it is also necessary to record the telephone conversations for legal matters and as proof of transaction. Using a separate computer and telephone network cannot fully meet those needs as it involves operating each individual system separately. That leads to inefficiencies and lack of productivity for agents, employees and the companies until the functions of the computer software applications and the telephony component can be fully integrated into one seamless solution. There is, therefore, a great need of small and medium sized companies for an improved and integrated computer/telephone environment to service a range of diversified business needs.

In terms of today's computer/telephone requirements and depending on the users' needs, a standard computer (when used in a telephony application) or a telephone instrument is usually equipped with electro-acoustical conversion components such as handset, headset, earphone or microphone.

For example, the user utilizes a PC headset connected to the sound card of the PC for a VOIP conversation, but also needs to have a conversation on the telephone instrument connected to the Public Switching Telephone network (PSTN) or PBX, or the reverse. The user needs to use separate electro-acoustical components, as these are usually compatible for neither the computer nor the telephone instrument. It is inconvenient, but can increase the cost of the solution as a result of the requirement for two separate electro-acoustical devices to perform the same function, namely a telephony based conversation; thus, there is a great need for an improved and integrated device.

Thus, to overcome the aforementioned problems of the existing and flawed technology, it would be an improvement if new technology could provide an integrated platform between computer and telephone instrument to significantly improve the efficiency and various needs of diversified businesses.

To this end, based on many years of experience and application in the production, development and design of related products, through deliberate design and evaluation, the inventor has created the present invention to meet all the practical needs of the aforementioned problems.

### SUMMARY OF THE INVENTION

The features and the advantages of the present invention will be more readily understood after thoughtful deliberation of the following detailed description and reference to the accompanying diagrams.

The objective of the present invention is to provide a telephone instrument that can be connected to a computer via data and audio connection interfaces to complement and maximize each other's unique functionality into a single and powerful telephone information technology solution, whereby the computer's functions (such as great processing power, internet integration and database capabilities) are fully integrated with the telephone instrument's (fixed line) functions (such as off-hook and on-hook signaling, dialing, connecting, disconnecting, incoming call display, and incoming call ring), where each device can send and receive information or signaling to the other in a seamless fashion.

For example, the computer can instruct the phone to go off-hook and dial a specific number within it's database, or to lock/unlock the keypad; in turn, the telephone instrument can send a signal to the computer to notify it there is a message waiting on the PBX/PSTN exchange and notify it of the calling number identification. It increases not only the telephone instrument's efficiencies but also that of the computer.

Another objective of the present invention is to provide a computer/telephone integrated solution, linked via wired or wireless data and audio interfaces, to offer users more flexibility and convenience.

Another objective of the present invention is to provide a computer/telephone integrated solution, with a switching device within the telephone instrument that can be controlled from the computer (based on the particular application), to switch an electro-acoustical conversion device. For example, a headset (501), to the telephone instrument (100) or to the computer's (400) PC sound card I/O (input-output), and by so doing to share one electro-acoustical device between the computer and telephone instrument. Thus, it reduces equipment wastage and makes it more user-friendly and convenient for the user.

### DETAILED DESCRIPTION OF THE PREFERRED APPLICATION

As shown in FIGS. 1 and 2, a circuit block diagram of the computer connected to the telephone using a wired or wireless interface; the telephone instrument (100) comprising the following: phone junction box (101), rectification protective circuit (102), power supply circuit (103), polarity reversal message circuit (104), ring indicator and high voltage message circuit (105), ring detection circuit (106), Loop control circuit (107), dialing control circuit (108), message waiting indicator circuit (109), keypad (110), speech circuit (111), speaker dialing circuit (112), handset (113) and speaker (114), which make up the complete phone circuit, though the telephone instrument (100) can be equipped with additional circuits and functionality depending on the application or need. For example, placing a wireless transmit and receive control circuit (200) in the telephone instrument (100), thereby the telephone (100) can be connected to the computer (400) via the data bus interface (300) to access all the functions of the computer (400), including great processing power, internet integration and database capabilities; moreover, the data bus interface (300) can be wired as shown in FIG. 1, or wireless as shown in FIG. 2. In terms of today's computer technology, the data bus interface (300) includes RS 232 or Universal Serial Bus (USB) or Firewire options.

Since the telephone (100) is linked to the computer (400) by the data bus interface (300), the computer (400) is able to receive all signals sent by the telephone (100), including on-hook and off-hook, dial tone, DTMF dialing, connecting, disconnecting, incoming call display and incoming call ring. These signals can then be interpreted by the computer's (400) software applications to start or stop call recording, playback call recording, accept key signals from the telephone (100) as well as to control and operate all the functions and keys on the telephone (100), including dialing, keypad lock/unlock, message waiting LED on/off activation, to further increase the functionality and efficiency of the telephone (100).

Herewith some examples of an integrated computer/telephone solution:

Application 1

As shown in FIG. 3, when the telephone (100) receives an incoming call, it can identify the caller information such as number and name, if available, feed it to the computer's (400) database, and then display all the information of that caller on the computer screen, as stored in the database. The call can be received using either the headset or handset, or switched between the two, depending on the user's requirement. If required and based on the status of the telephone (100) and the user's instructions, the computer (400) can record the telephone call to the database for purposes of retrieval and playback in future, as may be required by the company (such as marketing campaigns, call centers and emergency and security companies)

Application 2

As shown in FIG. 4, the computer (400) can be asked to search or inquire the data from the database, based on the specific criteria typed by the user such as name, telephone number, account number, or other. The computer (400) will then display the results on the screen, showing the complete customer information, with which the user can then select. For example, dial the contact number of the customer by having the computer (400) sending the relevant data to the telephone instrument (100) via the data bus interface (300) for dialing. To analyze the tones on line is the ring back tone of free line or the busy tone of busy line after make a dialing. At the same time, based on the status of the telephone (100) and the user's instructions to the database, the computer (400) can be instructed to record the dialogues on line for purposes of retrieval and playback in the future, as may be required by the company (such as marketing campaigns, call centers and emergency and security companies).

In terms of the function of the current telephone (100), the above-mentioned is possible with only a single telephone instrument (100) connected via the data bus interface (300) to a single computer (400), making the solution practical and effective.

FIGS. 5 and 6 are circuit block diagrams of a switching device (500) added to the original computer (400), and telephone (100) circuit diagrams, FIGS. 1 and 2, show the connection via a wired or wireless interface. The present invention adds the switching device (500) to the telephone (100) so that all electro-acoustical conversion devices (such as handset, headset, earphone and microphone) can be operated either on telephone or computer through the switching device (500). For example, a headset (501) can be shared between the telephone instrument (100) and the computer (400) to handle telephone calls from an Internet source (VOIP) via the computer (400), or telephone calls from a telephone network source (i.e. PSTN or PBX) via the telephone instrument (100). Thus, it reduces the cost of implementation and wastage of purchasing additional but separate electro-acoustical devices.

Application 3

As shown in FIG. 7, the switching device (500) can switch the electro-acoustical conversion equipment (501) to the computer (400) if there is a need. For example, to listen to music from the computer or to make a VOIP call via the Internet, or alternatively to switch the electro-acoustical conversion equipment (501) to the telephone (100) for purposes of answering the phone when it is ringing or making an outbound call through the telephone network.

The switching device (500) can be controlled automatically by the computer's (400) software application depending on certain pre-programmed criteria and telephone (100) status; alternatively, it can be switched manually by the user depending on the requirement.

This invention is a circuitry design based on and invented from the IC, to achieve the same aforementioned functions that it could be invented by various circuitry designs. The distinguishing feature of the present invention and concept, which is to possess interactive function to integrate telephone with computer utilities, is not only theorized on circuit diagrams and flow charts but also possesses its practicability. Therefore, we hereby apply the patent for this new invention.

Although the invention has been explained in relation to its preferred applications, it is to be understood that many other possible modifications and variations can be made without departing from the objective and scope of the invention as herein claimed and those modifications and variations as well as similar inventions should be included in this application.

### BRIEF DESCRIPTION OF THE DRAWINGS

FIG. 1 shows the circuit block diagram of the computer connected to the telephone via a wired interface.

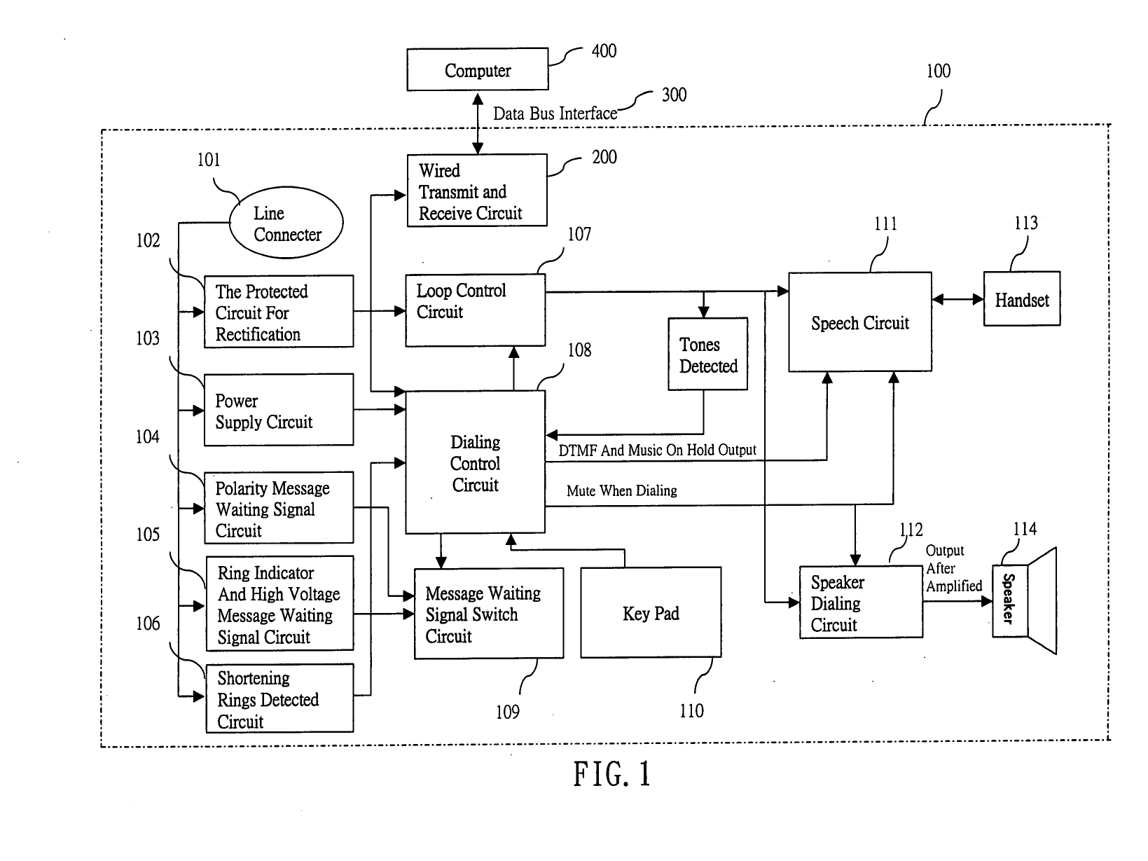

FIG. 2 shows the circuit block diagram of the computer connected to the telephone via a wireless interface.

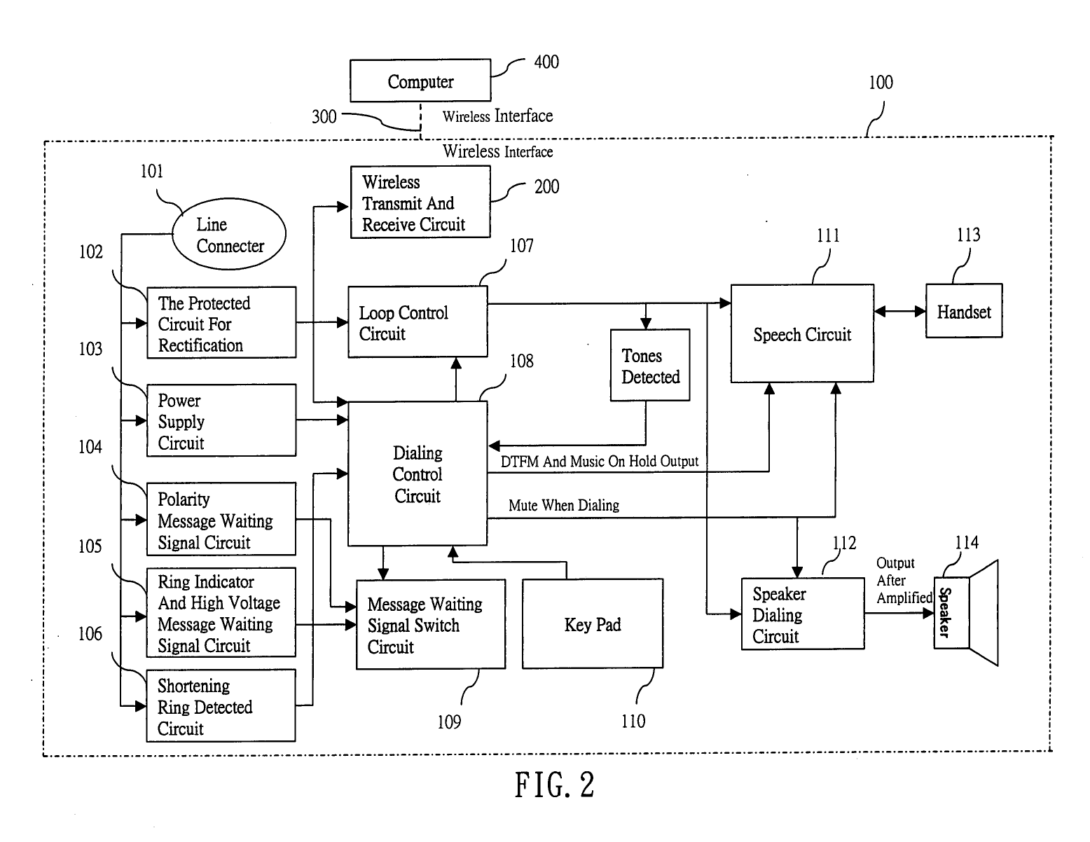

FIG. 3 shows the flow chart of an application of the present invention.

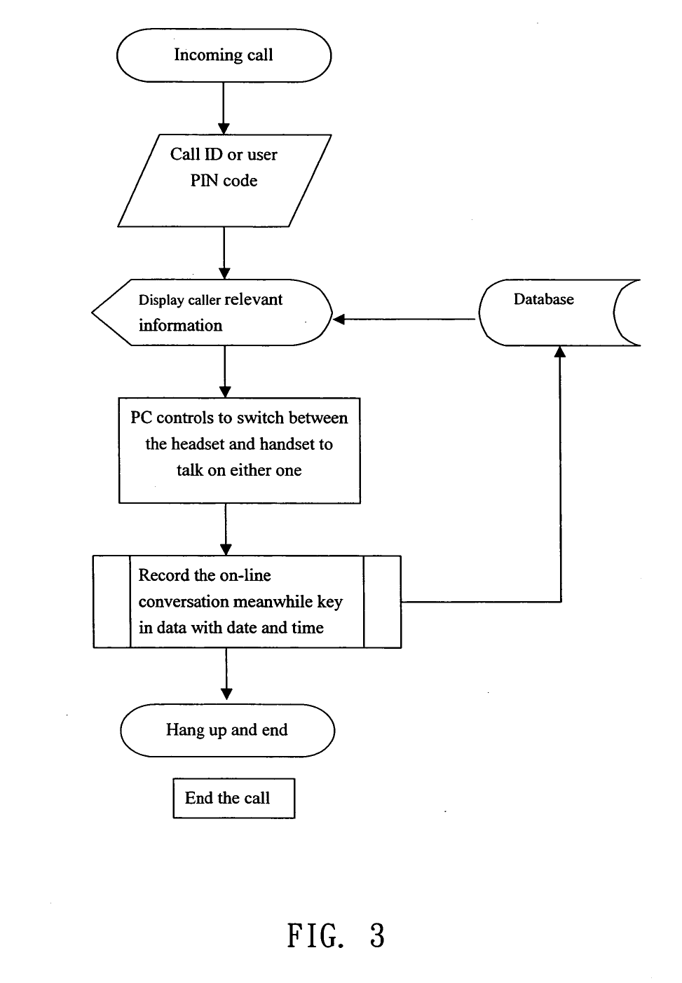

FIG. 4 shows the flow chart of another application for the present invention.

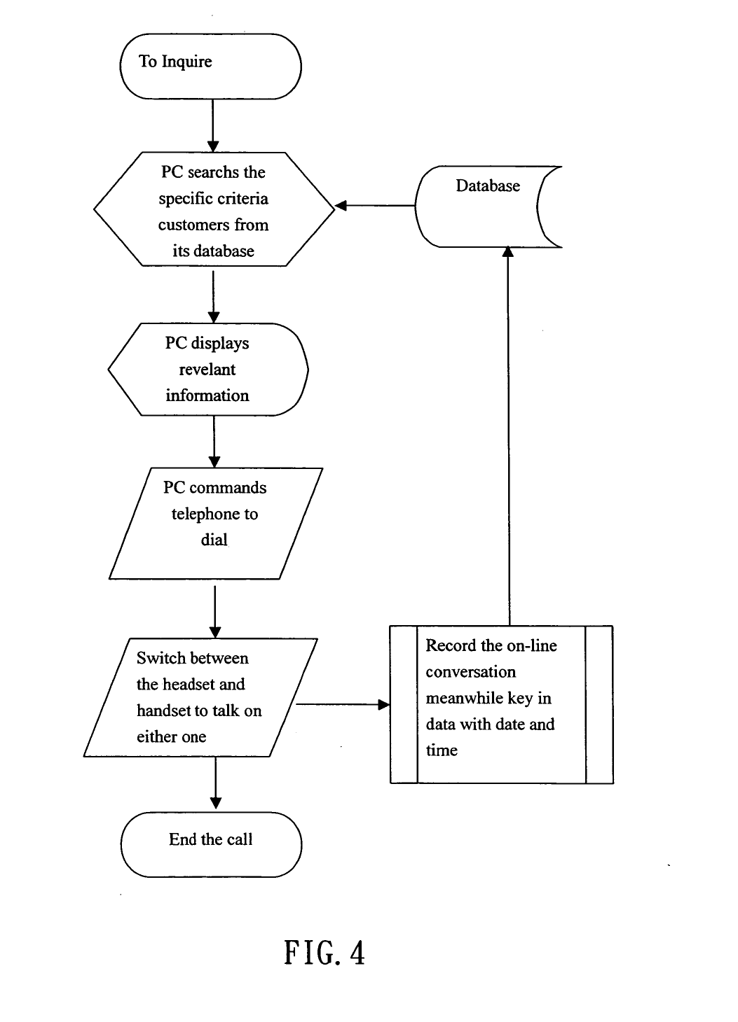

FIG. 5 shows the circuit block diagram of the present invention with a wired interface to the computer and with the switching device added.

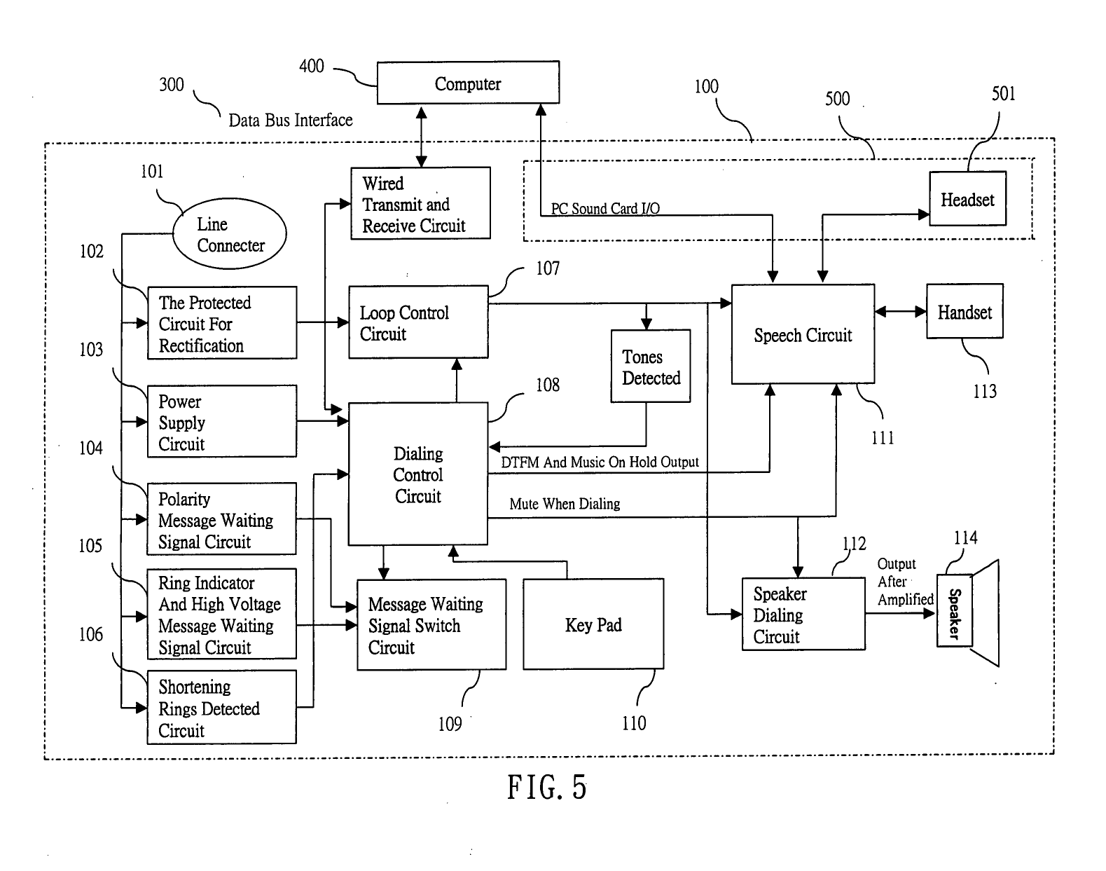

FIG. 6 shows the circuit block diagram of the present invention with a wireless interface to the computer and with the switching device added.

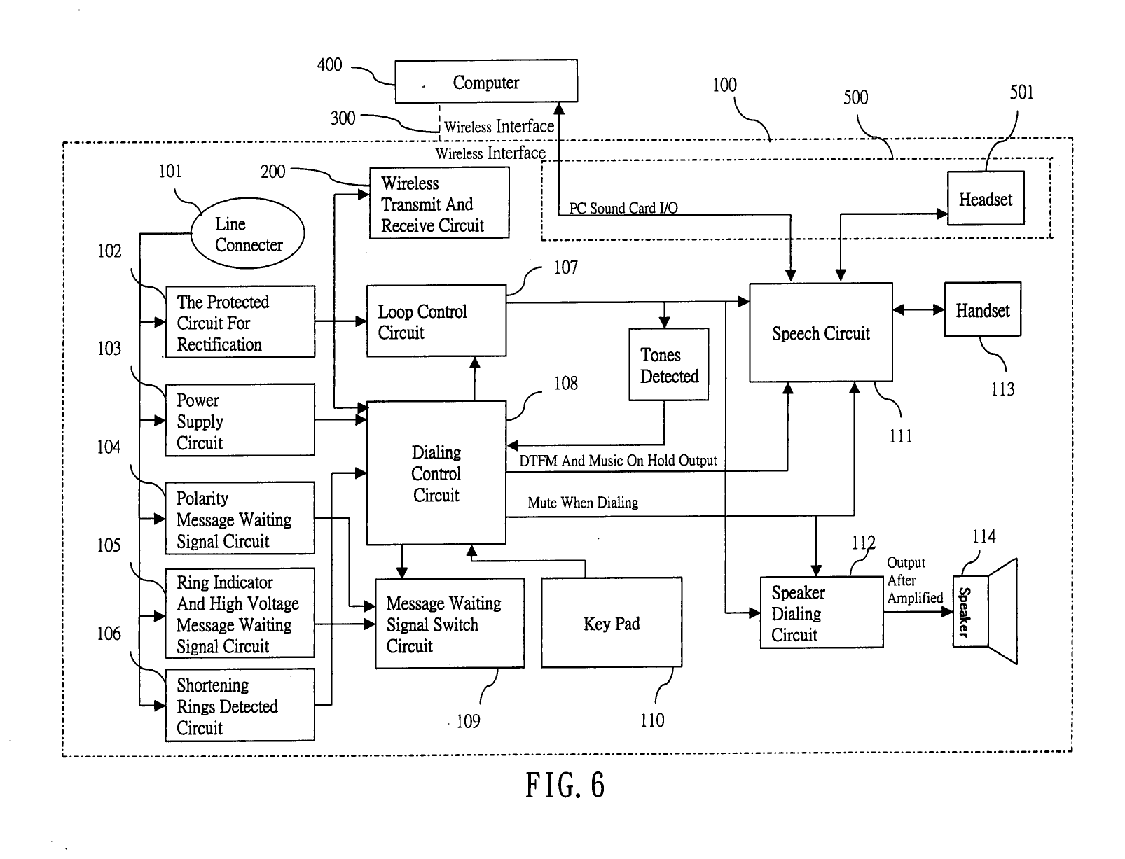

FIG. 7 shows the flow chart of an application that makes use of the device with the present invention.

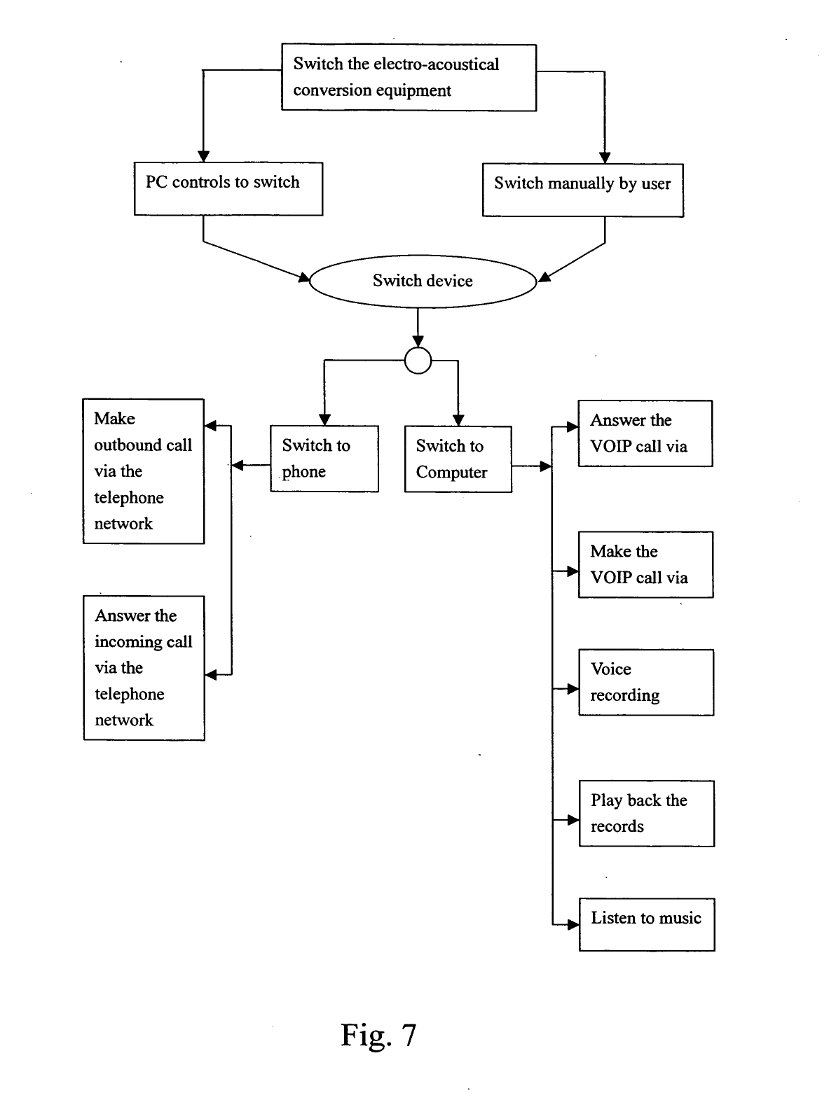

What is claimed is:

1. A telephone instrument that can be connected to a computer via data and audio connection interfaces, so that the functions of the computer such as great processing power, internet integration and database capabilities are integrated in a seamless fashion with the telephone instrument, and where it can receive and interpret the telephone's signaling information to start or stop voice recording, playback call recordings, accept key signals as well as to control and operate all the functions and keys on the telephone.

2. The telephone instrument used in conjunction with a computer as claimed in claim 1, wherein the connection interface includes RS232 or Universal Serial Bus (USB) or Firewire.

3. The telephone instrument used in conjunction with a computer as claimed in claim 1, wherein the connection interface is wired.

4. The telephone instrument used in conjunction with a computer as claimed in claim 1, wherein the connection interface is wireless.

5. The telephone instrument used in conjunction with a computer as claimed in claim 1, wherein the function of the computer includes amongst others, its processing power, internet integration and database capabilities.

6. The telephone instrument used in conjunction with a computer as claimed in claim 1, wherein the computer can receive various signaling information from the telephone such as off-hook and on-hook signaling, outbound dialing, connecting, disconnecting, incoming call display, and incoming call ring.

7. The telephone instrument used in conjunction with a computer as claimed in claim 1, wherein the computer can control and operate all the functions and keys on the telephone, including dialing, keypad lock/unlock and message waiting LED on/off activation.

8. The telephone instrument used in conjunction with a computer as claimed in claim 1, wherein a switching device on the telephone can be used to switch a single electro-acoustical conversion device to either the computer (soundcard) or to the telephone (telephone network).

9. The telephone instrument used in conjunction with a computer as claimed in claim 8, wherein the switching device can be automatically controlled and switched by the computer.

10. The telephone instrument used in conjunction with a computer as claimed in claim 8, wherein the switching device can be manually controlled and switched by the user.
